(19) United States
(12) Patent Application Publication
(10) Pub. No.: US 2004/0059558 A1
(43) Pub. Date: Mar. 25, 2004

(54) Hierarchical reduced-order circuit model for clock net verification

(76) Inventor: Alexander I. Korobkov, Sunnyvale, CA (US)

Correspondence Address: John C. Kennel, CAMPBELL STEPHENSON ASCOLESE LLP, Bldg. 4, Suite 201, 4807 Spicewood Springs Rd., Austin, TX, 78759, US

(21) Appl. No.: 10/252,641

(22) Filed: Sep. 23, 2002

(51) Int. Cl. G06F 17/50

(52) U.S. Cl. 703/14

(57) ABSTRACT

A method and system for providing a realizable reduced-order model for a circuit. The method includes calculating a value for each component of said realizable reduced-order model. The calculating is based upon properties of a signal provided to the circuit and a voltage range associated with the circuit. If at least one of the values is not positive, the voltage range is modified and the calculating step is repeated until each of the values is positive.

### FIELD OF THE INVENTION

The present invention relates generally to circuit simulation and verification, and more specifically, to a method of generating a reduced-order model circuit.

### DESCRIPTION OF THE RELATED ART

Typically in circuit design, the verification and/or timing simulation of a clock distribution network and other circuit parameters is accomplished by computer programs which model the existing circuit as a netlist, then perform timing simulations and/or verifications on the netlist. However, as circuits become more complex, the circuit verification and timing simulation process becomes more complex and time consuming.

The clock distribution network for a high-speed processor design is usually distributed over the entire chip and may include interconnect wires coupled to clock buffers and numerous clock sensitive flip-flops. Current software tools designed to simulate the physical design of such a complex circuit may produce a very large netlist composed of a number of resistors, capacitors, inductors and transistors. Additionally, the size and complexity of the netlist is increased when taking into account the many wire-to-wire couplings within the circuit. Unfortunately, existing timing simulators and circuit verification programs are unable to process such a netlist with proven accuracy and efficiency.

Traditional methods of improving the accuracy and efficiency of circuit simulation and verification have included reducing the size and the complexity of the circuit under simulation by modeling the circuit as a number of reduced-order models and, then performing a timing simulation and verification process on the reduced-order models. These reduced-order models have traditionally been represented by capacitors. Although capacitor representation provides an adequate solution for a circuit driven at one point, capacitor representations fail to provide accurate results for multi-driven netlists, which are commonly used to simulate multi-processor circuits. Additionally, traditional methods employing the capacitor model fail to provide accurate results for resistance and inductance dominated circuits and circuits including non-monotonic signal waveforms.

### SUMMARY OF THE INVENTION

The present invention relates to a method and system for providing a realizable reduced-order model for a circuit. The method includes calculating a value for each component of the realizable reduced-order model. The calculation is based upon properties of a signal provided to the circuit and a voltage range associated with the circuit. If at least one of the values is not positive, the voltage range is modified and the calculation step is repeated until each of the values is positive.

The foregoing is a summary and thus contains, by necessity, simplifications, generalizations and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings.

FIG. 1 is a flow chart illustrating the actions generally performed in simulating a circuit according to the present invention.

FIG. 2 is a flow chart illustrating the actions generally performed in computing a reduced-order model for a circuit to be simulated according to the present invention.

FIG. 3 illustrates exemplary reduced-order models for use in the present invention.

FIG. 4 illustrates an exemplary circuit, including hierarchical blocks, which can be simulated according to the present invention.

FIG. 5 illustrates a reduced-order model computed for a hierarchical block, according to the present invention.

FIG. 6 illustrates the computation of a driving point waveform for a reduced-order model, according to the present invention.

FIG. 7 illustrates the simulation of a circuit using the driving point waveform computed in FIG. 6, according to the present invention.

FIG. 8 is a block diagram illustrating exemplary driving point waveforms for use in computing realizable reduced order model parameters according to the present invention.

FIG. 9 is a block diagram illustrating a computer system suitable for implementing embodiments of the present invention.

### DETAILED DESCRIPTION

Introduction

Generally, embodiments of the present invention provide a system and method for efficiently and accurately simulating a complex circuit responsive to non-monotonic signals. As used herein, a non-monotonic signal is a signal which does not increase or decrease steadily. For example, if during the falling edge of a clock signal, the signal plateaus or even rises a bit, the transition is said to be a non-monotonic transition. Similarly, as an example, if a steadily increasing signal plateaus or deceases then begins rising again, the signal is said to be non-monotonic. The following is intended to provide a detailed description of an example of the invention and should not be taken to be limiting of the invention itself. Rather, any number of variations may fall within the scope of the invention which is defined in the claims following the description.

Advantages provided by the present invention include (1) by having positive values of components, the realizable reduced-order circuit can be simulated with a computer simulation tool (2) the realizable reduced-order model circuit is a much smaller circuit than the original circuit, which allows for a decrease in the overall time it takes for simulations to occur, (3) timing simulation and verification of the original circuit can be performed on individual hierarchical blocks via the driving point waveform, which decreases the overall time it takes to perform the timing simulation and/or verification of the original circuit, and (4) the overall timing simulation and/or verification results provided with the present invention are accurate for multi-driven netlists, netlists which include resistance and/or inductance dominated circuits and/or circuits driven by non-monotonic signals.

Exemplary Embodiments

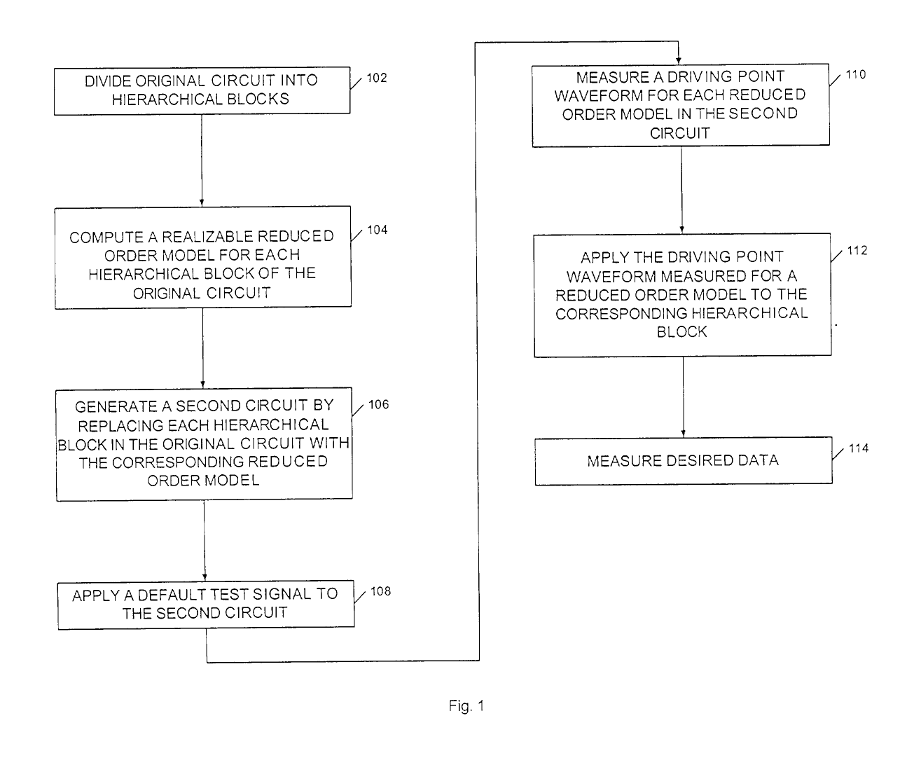

FIG. 1 is a flow chart illustrating the actions generally performed in simulating a circuit according to embodiments of the present invention. Initially, an original circuit is divided into hierarchical blocks (i.e., sub-circuits) (step 102). The original circuit is preferably any circuit for which timing simulation and/or design verification is to be performed. One example of such a circuit is a processor. Any method of dividing the original circuit into hierarchical blocks may be used. For example, in dividing a circuit into hierarchical blocks, a schematic of an existing circuit is divided, either by hand or through the use of a computer design tool, such that no hierarchical blocks share common elements. In the described embodiment, each hierarchical block is an original design block which, when assembled with other design blocks, form the original circuit. It is preferable that when dividing the circuit into hierarchical blocks, no physical elements (e.g., wires) are shared between hierarchical blocks.

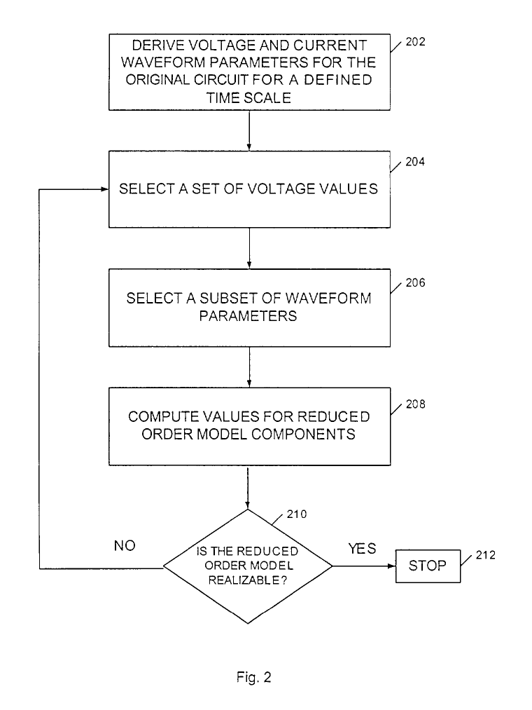

Once the original circuit has been divided into hierarchical blocks, a realizable reduced-order model is computed for each hierarchical block in the original circuit (step 104). In general, the reduced-order model is one of two types of reduced-order models: a reduced-order transfer function model or a reduced-order driving point admittance model. It is preferable that driving point admittance models be used due to the bottom-up approach associated with driving point admittance model, which allows for portions of a circuit to be separated and analyzed apart from the original circuit. Additionally, the driving point admittance model is preferable for use in timing simulations. The computation of the reduced-order model is discussed in more detail with reference to FIG. 2 below.

Following the computation of the reduced-order models, each of the hierarchical blocks within the original circuit are replaced with the corresponding computed reduced-order models (step 106). In the described embodiment, this is accomplished by modifying the netlist of the original circuit so that each hierarchical block is replaced with the corresponding reduced-order model. Next, an input signal is applied to the modified circuit (step 108), (“modified circuit” is used herein to describe the original circuit with the hierarchical blocks replaced by corresponding reduced-order models). In one embodiment of the present invention, the input signal is similar to an actual input signal applied to the original circuit (e.g., a clock signal). In the described embodiment, the signal is a clock signal and is applied to the modified circuit by a special purpose clock generator circuit via a computer simulation program such as SPICE.

Following the application of the input signal, a driving point waveform is measured for each reduced-order model in the modified circuit (step 110). In the described embodiment, the driving point waveform is measured at the primary node of the reduced-order model. The primary node represents a node where the reduced-order model is coupled to the original circuit. The measured driving point waveform represents a substantially similar, if not identical, waveform that would result from the application of the same input signal to the original circuit and measurement from a similarly located node.

The measured driving point waveform obtained from step 110 is applied to the corresponding hierarchical block, separated from the original circuit (step 112). In the described embodiment, the application of the measured driving point waveform is accomplished via a computer simulation program such as SPICE. Following the application of the driving point waveform, the desired timing simulation data or circuit verification is measured at any desired node of the hierarchical block (step 114).

It can be seen that advantages provided by the present invention include (1) the modified circuit is a much smaller circuit than the original circuit, which allows for a decrease in the overall time for signal measurements to occur, and (2) timing simulation and verification of the original circuit can be performed on individual hierarchical blocks via the driving point waveform, which decreases the overall time it takes to perform the timing simulation and/or verification of the original circuit.

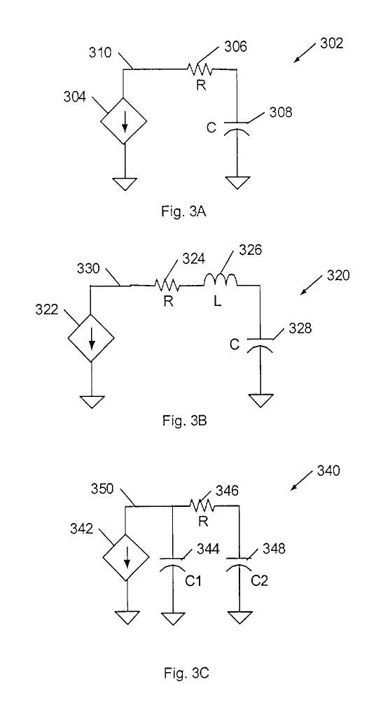

FIG. 2 is a flow chart illustrating the actions generally performed in computing a reduced-order model for a circuit to be simulated according to the present invention. Before describing the actions of FIG. 2, a brief discussion of reduced-order models is now presented with reference to FIG. 3.

FIG. 3 illustrates exemplary reduced-order models for use in the present invention and known linear equations for calculating values of components of the reduced-order models. The reduced-order models discussed in FIG. 3 are accurate for resistance dominated circuits and work well with circuits including inductance or other elements capable of producing non-monotonic signal waveforms.

FIG. 3A illustrates a L-type first order model 302 which is preferably used for first order resistance-dominated effects within a circuit. L-type model 302 includes a current source 304 coupled to a resistor 306 and a capacitor 308 via a transmission wire 310. The values of resistor 306 and capacitor 308 depend on the values of the voltage and current applied to L-type model 302 over time. The values of resistor 306 and capacitor 308, are preferably computed by solving for R and C, respectively, in Equation 1:

$$[ \begin{matrix}{\hat{i}}_{21} & {i}_{21} \\ {\hat{i}}_{31} & {i}_{31}\end{matrix} ] \cdot [ \begin{matrix}\frac{1}{C} \\ R\end{matrix} ] = [ \begin{matrix}{v}_{21} \\ {v}_{31}\end{matrix} ] \qquad ( 1 )$$

The subscripts xy associated with voltage (v) and current (i) represent a time scale in which the respective voltage and current computations are measured. For example i₂₁ indicates that a current is computed between time t2 and time t1. When selecting sampling points, it is preferable that t3>t2>t1. Also, iⱼₖ is given by iⱼ−iₖ, vⱼₖ is given by vⱼ−vₖ, and îⱼₖ is given by the integral of the current i(t) over a time period defined by tⱼ to tₖ. This integral of the current i(t) is expressed mathematically in Equation 2 as:

$${\hat{i}}_{jk} = {\int }_{{t}_{i}}^{{t}_{k}} i ( t ) ⅆ t \qquad ( 2 )$$

FIG. 3B illustrates a L-type second order model 320 which is preferably used for second order inductance impacts within a circuit. L-type model 320 includes a current source 322 coupled to a resistor 324, an inductor 326, and a capacitor 328 via transmission wire 330. The values of resistor 324, inductor 326, and capacitor 328 depend on the values of the voltage and current applied to L-type model 320 over time. The values of resistor 324, inductor 326, and capacitor 328, respectively, are preferably computed by solving for R, L, and C, respectively, in Equation 3:

$$[ \begin{matrix}{\hat{i}}_{21} & {i}_{21} & {\overline{i}}_{21} \\ {\hat{i}}_{31} & {i}_{31} & {\overline{i}}_{31} \\ {\hat{i}}_{41} & {i}_{41} & {\overline{i}}_{41}\end{matrix} ] \cdot [ \begin{matrix}\frac{1}{C} \\ R \\ L\end{matrix} ] = [ \begin{matrix}{v}_{21} \\ {v}_{31} \\ {v}_{41}\end{matrix} ] \qquad ( 3 )$$

In Equation 3, vⱼₖ is given by vⱼ-vₖ, îⱼₖ is given by iⱼ-iₖ, îⱼₖ is given by the integral of the current i(t) over a time period defined by tⱼ to tₖ, which is preferably expressed mathematically by Equation 2, and îⱼₖ is given by the derivative of iⱼ and iₖ, as expressed in Equation 4:

$${\overline{i}}_{jk} = \frac{ⅆ ( {i}_{k} - {i}_{j} )}{ⅆ t} \qquad ( 4 )$$

FIG. 3C illustrates a Pi-type second order model 340 which is preferably used for second order coupling effects within a circuit. Pi-type second order model 340 includes a current source 342 coupled to a capacitor 344, a resistor 346, and another capacitor 348, parallel to capacitor 348, via transmission wire 350. The values of capacitors 344 and 348, and resistor 346 depend on the values of the voltage and current applied to Pi-type second order model 340 over time. The values of resistor 346 and capacitors 344 and 348, respectively, are preferably computed by solving for R, C₁, and C₂, respectively, in Equation 5:

$$[ \begin{matrix}{\hat{i}}_{21} & {i}_{21} & {\overline{v}}_{21} \\ {\hat{i}}_{31} & {i}_{31} & {\overline{v}}_{31} \\ {\hat{i}}_{41} & {i}_{41} & {\overline{v}}_{41}\end{matrix} ] \cdot [ \begin{matrix}\frac{1}{{C}_{1} + {C}_{2}} \\ \frac{{C}_{2} \cdot R}{{C}_{1} + {C}_{2}} \\ \frac{{C}_{1} \cdot {C}_{2} \cdot R}{{C}_{1} + {C}_{2}}\end{matrix} ] = [ \begin{matrix}{v}_{21} \\ {v}_{31} \\ {v}_{41}\end{matrix} ] \qquad ( 5 )$$

In Equation 5, vⱼₖ is given by vⱼ-vₖ, îⱼₖ is given by iⱼ-iₖ, îⱼₖ is given by the integral of the current i(t) over a time period defined by tⱼ to tₖ, which as expressed mathematically by Equation 2 above, and \hat{v}ⱼₖ is given by the derivative of vⱼ and vₖ, as expressed in Equation 6:

$${\overline{v}}_{jk} = \frac{ⅆ ( {v}_{k} - {v}_{j} )}{ⅆ t} \qquad ( 6 )$$

Returning now to FIG. 2, initially, a reduced-order model is selected, preferably from one of the reduced-order models illustrated in FIG. 3. Once the desired reduced-order model has been chosen, it is necessary to compute the values of the components within the reduced-order model. This is accomplished in the described embodiment by defining a set of voltage and current waveforms over a defined time scale (step 202). In one embodiment of the present invention, the waveform is a piecewise linear signal which simulates the behavior of a non-linear input signal (e.g., a clock signal applied to the original circuit). In one embodiment, the waveform is defined by the following SPICE subcircuit:

| | |
|---|---|
| .paramsigoffset | = 0.40009163 |
| .param clk_per | = 900ps |
| .param rise_default | = 83.33ps |
| .param fall_default | = 83.33ps |

.param delay_default= ′sigoffset*rise_default+10ps′
.subckt clkinput out delay=delay_default riseSlope=rise_default
fallSlope=fall_default
Rint int out 0.01
Vi int vss pwl
+ ′delay+(0.00000000-sigoffset)*riseSlope′
′vlow+0.00000000*(vhigh-vlow)′
+ ′delay+(0.04360398-sigoffset)*riseSlope′
′vlow+0.01785714*(vhigh-vlow)′
. . .
+ ′delay+(1.90459171-sigoffset)*riseSlope′
′vlow+1.00000000*(vhigh-vlow)′
+ ′(clk_per/2)+delay+(0.00000000-sigoffset)*fallSlope′
′vhigh-0.00000000*(vhigh-vlow)′
. . .
+ ′(clk_per/2)+delay+(1.90459171-sigoffset)*fallSlope′
′vhigh-1.00000000*(vhigh-vlow)′
+ ′clk_per+delay+(0.00000000-sigoffset)*riseSlope′
′vlow′0.00000000*(vhigh-vlow)′
+ R ′delay+(0.00000000-sigoffset)*riseSlope′
.ends

Within the defined time scale and voltage range, a set of voltage values are selected (step 204) and, if necessary, a subset of waveform parameters are selected (step 206). It is preferable that, at least initially, the selected voltage parameters span the largest possible voltage range, for example Vss to Vdd. Additionally, it is preferable that the number of voltage values selected be one greater than the number of variables in the reduced-order model equation. For example, it is preferable that at least three voltage levels spanning Vss to Vdd be selected initially for solving Equation 1, since two variables, R and C, must be solved for. According to the present invention, the stability of the circuit is improved by having at least one more measurement (i.e., voltage value) than the number of variables to be solved for.

In step 208, the component values of the reduced-order model are computed. In the described embodiment, this computation is accomplished by entering the selected voltage values, current values, and their integrals and derivatives depending on which model has been selected, into a circuit simulation program, such as SPICE. Any signal may be used to compute the reduced-order model. In one embodiment of the present invention, the signal is a non-linear signal with a medium slew rate.

Once the component values have been computed, a check is done to ensure that the resulting reduced-order model is realizable (decision block 210). A realizable reduced-order model is stable with respect to the driving point voltage, and as used herein, a realizable reduced-order model is a circuit model for which each component value (e.g., R value, C value, L value, etc) is positive, thus making it possible to utilize the realizable reduced-order model in a circuit simulation tool, such as SPICE. Continuing with FIG. 2, if the model is not realizable, another set of voltage levels are selected (“No” branch of decision block 210 and step 204) and the actions continue until the computed component values provide for a realizable reduced-order model (steps 206-210). When the computed component values provide a realizable reduced-order model, the computation of at least one reduced-order model is complete (“Yes” branch of decision block 210, and step 212).

According to one embodiment of the present invention, the actions of FIG. 2 are preferably implemented by the following pseudo-code to calculate, for example, the component values (R) and (C) for an L-type realizable reduced-order model:

define input piecewise linear waveform and t1, . . . t9;
verify V(t1), . . . v(t9) at t1, . . . t9; t1 < t2 < . . . < t9;
compute i(t1), . . . i(t9),

di(t1)/dt . . . di(t9)/dt for the defined signal waveform using spice;

set up v91 = v(t9) − v(t1); . . . v21 = v(t2) − v(t1);
T1 = t1; k = 9; 1 = 5; R = 0; C =0; done = FALSE;
while (((R <= 0) or (C <= 0 )) and (k > 2) and (1 > 1 )) {

T3 = tk; T2 = t1;
set up i21 = i(T2) − i(T1); di21 = di(T2)/dt − di(T1)/dt;
i31 = i(T3) − i(T1); di31 = di(T3)/dt − di(T1)/dt;
solve the system of linear equations (e.g., in Equation 1) to determine

component values (e.g., R,C);

if (done) 1 = 1 − 1; done = FALSE;
else k = k − 1; done = TRUE;

}

It will be recognized that the above pseudo-code is provided for aid and clarity in describing an embodiment of the present invention. Other pseudo-code according to another embodiment of the present invention may be used depending on the original circuit and desired simulations and verifications. Consequently, the present invention should not be limited to the pseudo-code provided above.

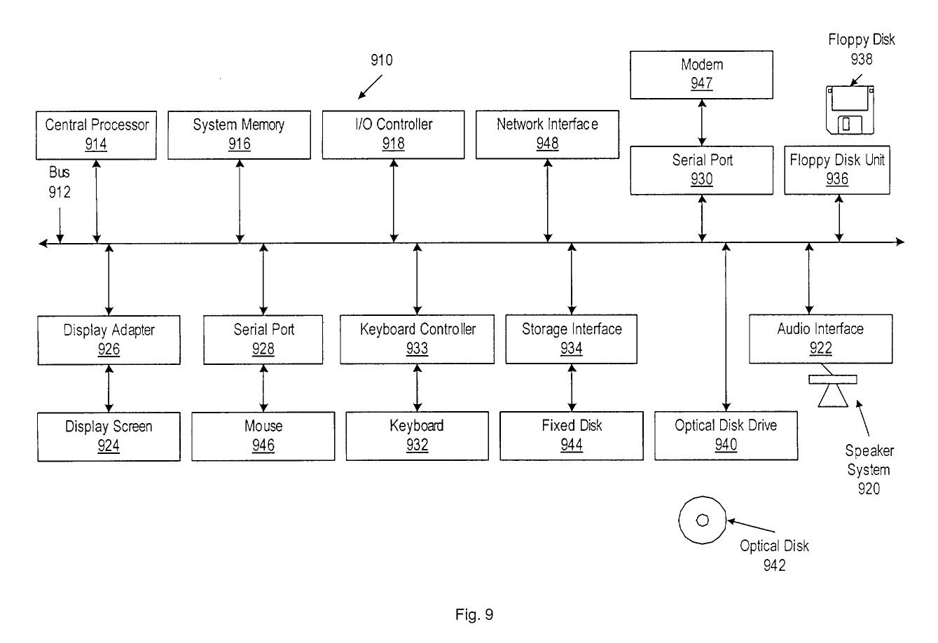

It will also be recognized that each of the blocks of FIG. 2 may be executed by a module (e.g., a software module) or a portion of a module or a computer system user. Thus, the above described method, the operations thereof and modules therefor may be executed on a computer system (e.g., computer system 910 of FIG. 9) configured to execute the operations of the method and/or may be executed from computer-readable media. The method may be embodied in a machine-readable and/or computer-readable medium for configuring a computer system to execute the method. Thus, the software modules may be stored within and/or transmitted to a computer system memory to configure the computer system to perform the functions of the module.

The software modules described herein may be received by computer system 910, for example, from computer readable media 942. Computer readable media 942 may be permanently, removably or remotely coupled to computer system 910. Computer readable media 942 may non-exclusively include, for example, any number of the following: magnetic storage media including disk and tape storage media; optical storage media such as compact disk media (e.g., CD-ROM, CD-R, etc.) and digital video disk storage media; nonvolatile memory storage memory including semiconductor-based memory units such as FLASH memory, EEPROM, EPROM, ROM or application specific integrated circuits; volatile storage media including registers, buffers or caches, main memory, RAM, etc.; and data transmission media including computer network, point-to-point telecommunication, and carrier wave transmission media. In a UNIX-based embodiment, the software modules may be embodied in a file which may be a device, a terminal, a local or remote file, a socket, a network connection, a signal, or other expedient of communication or state change. Other new and various types of computer-readable media may be used to store and/or transmit the software modules discussed herein.

Alternatively, such actions may be embodied in the structure of circuitry that implements such functionality, such as the micro-code of a complex instruction set computer (CISC), firmware programmed into programmable or erasable/programmable devices, the configuration of a field-programmable gate array (FPGA), the design of a gate array or full-custom application-specific integrated circuit (ASIC), or the like.

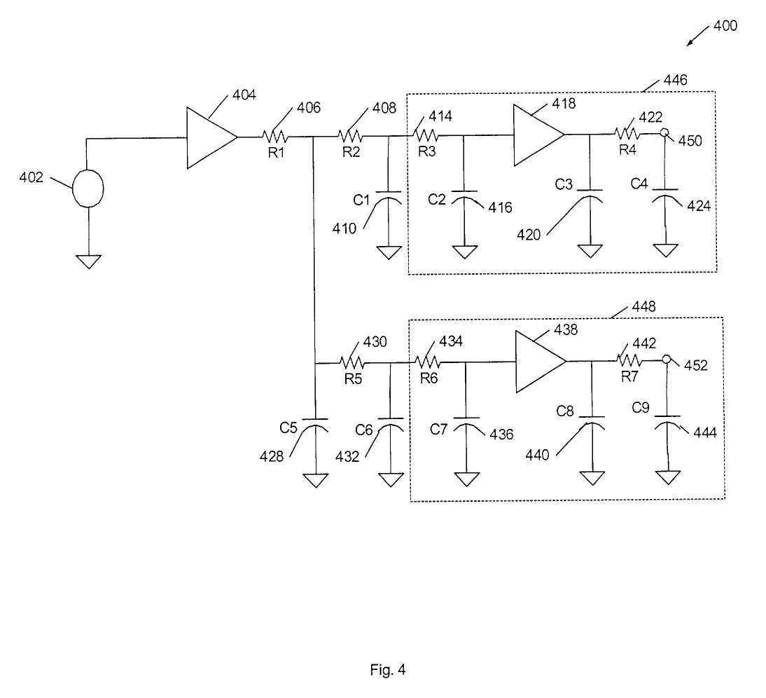

FIG. 4 illustrates an exemplary circuit 400 which can be simulated according to embodiments of the present invention. Generally, embodiments of the present invention can be used to simulate circuits, such as ultra-high-speed processors for example, which can contain millions of components (i.e., circuit elements). Circuit 400 is described within the contexts of the present invention so as to provide a clear and concise description of the present invention, and should not be taken as limiting.

Circuit 400 includes a voltage source 402 coupled to a buffer 404 which is coupled to a resistor 406. Resistor 406 is coupled to a resistor 408, which is coupled to a capacitor 410 and a resistor 414. Resistor 414 is coupled to a capacitor 416 and a buffer 418. Buffer 418 is coupled to a capacitor 420 and a resistor 422, which is coupled to a capacitor 424. Resistor 406 is also coupled to a capacitor 428 and a resistor 430. Resistor 430 is coupled to a capacitor 432 and a resistor 434. Resistor 434 is coupled to a capacitor 436 and a buffer 438. Buffer 438 is coupled to a capacitor 440 and a resistor 442, which is coupled to a capacitor 444.

As illustrated in FIG. 4, circuit 400 is divided in to hierarchical blocks 446 and 448. In the described embodiment, circuit 400 is divided into hierarchical blocks 446 and 448 during the design phase of circuit 400. Hierarchical block 446 includes resistor 414, capacitor 416 buffer 418, capacitor 420, resistor 422, and capacitor 424. Hierarchical block 448 includes resistor 434, capacitor 436, buffer 438, capacitor 440, resistor 442, and capacitor 444. It is preferable that circuit 400 be divided into hierarchical blocks 446 and 448 such that no transmission lines are shared between each. Although hierarchical block 446 and 448 contain similar circuitry, other hierarchical blocks can contain circuitry different from each other. By dividing circuit 400 into hierarchical blocks which do not share transmissions lines, replacement of each hierarchical block with a corresponding reduced-order model is made easier, as described below.

It is desirable to perform timing simulations and/or circuit verification of circuit 400 at measurement points 450 and 452. By using the methods of the present invention as described herein, such timing simulations and/or circuit verifications can be performed much quicker than if such timing simulations were to be performed on the original circuit.

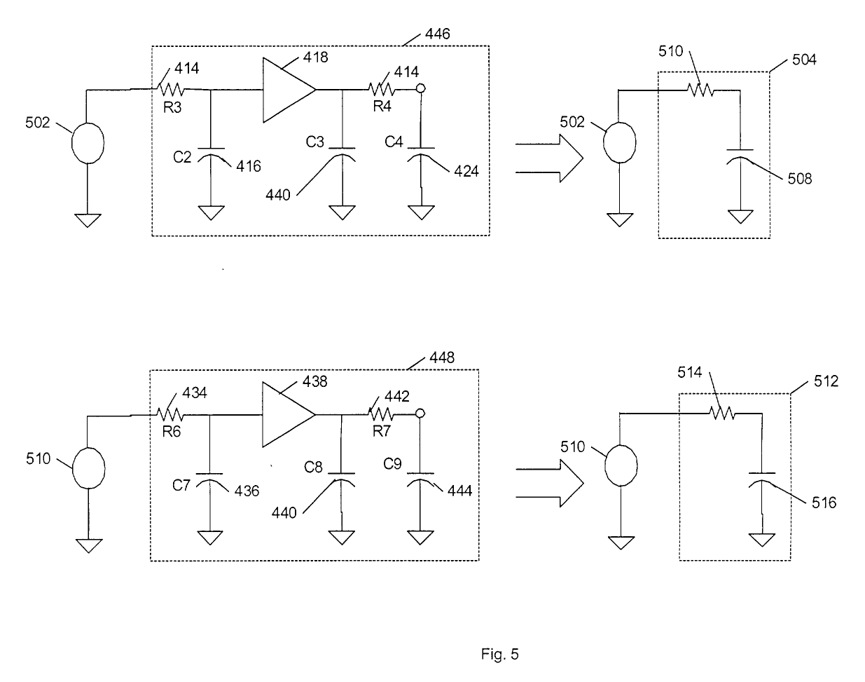

Referring to the actions described in FIG. 2 as a guide to implementing the present invention on exemplary circuit 400, FIG. 5 illustrates a realizable reduced-order model computed for each hierarchical block of circuit 400. As illustrated in FIG. 5, hierarchical block 446 is coupled to voltage source 502. Voltage source 502 represents the application of voltage values and waveform parameters applied to hierarchical block 446 in order to compute the components for a reduced-order model 504. In the described embodiment, hierarchical block 446 is represented by L-type first order model 504, including resistor 506 and capacitor 508.

Similarly, hierarchical block 448 is coupled to voltage source 510. Voltage source 510 represents the application of voltage values and waveform parameters applied to hierarchical block 448 in order to compute the components for a reduced-order model 512. In the described embodiment, hierarchical block 448 is represented by L-type first order model 512, including resistor 514 and capacitor 516.

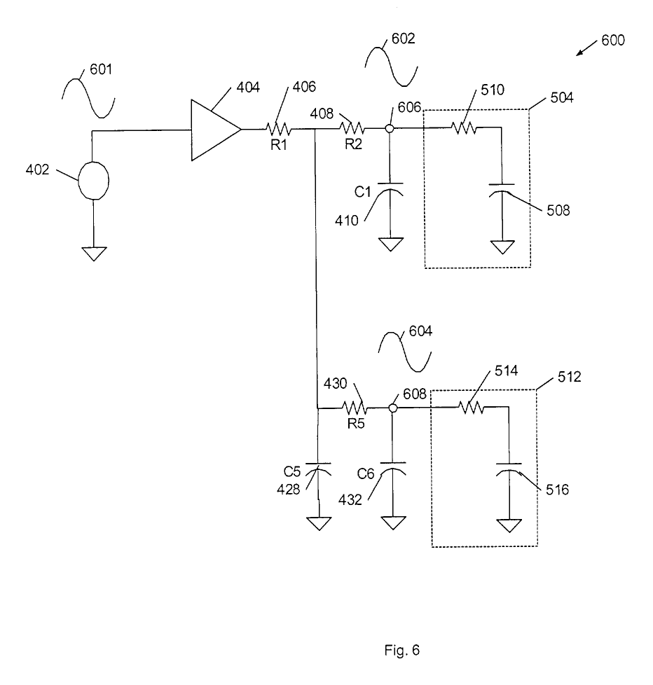

Following the computation of the reduced-order models 504 and 512, hierarchical blocks 446 and 448 of original circuit 400 are replaced by reduced-order models 504 and 512, respectively, as illustrated in FIG. 6. Modified circuit 600 includes original circuit 400 with hierarchical block 446 replaced with reduced-order model 504 and hierarchical block 448 replaced with reduced-order model 512. Once preferably each hierarchical block of original circuit 400 has been replaced with the corresponding reduced-order model, a default voltage signal 601 is applied by voltage source 402 to modified circuit 600. Default voltage signal 601 provides driving point waveforms 602 and 604, which are measured at nodes 606 and 608, respectively. Because reduced-order models 504 and 512 are a much simpler circuit than hierarchical blocks 446 and 448, respectively, the time to provide and measure driving point waveform 602 and 604 is less than the time it would take for original circuit 400. Further, reduced-order models 504 and 512 computed in accordance with embodiments of the present invention, are accurate enough to represent the behavior of hierarchical blocks 446 and 448 (i.e., the original circuit) for any input signal.

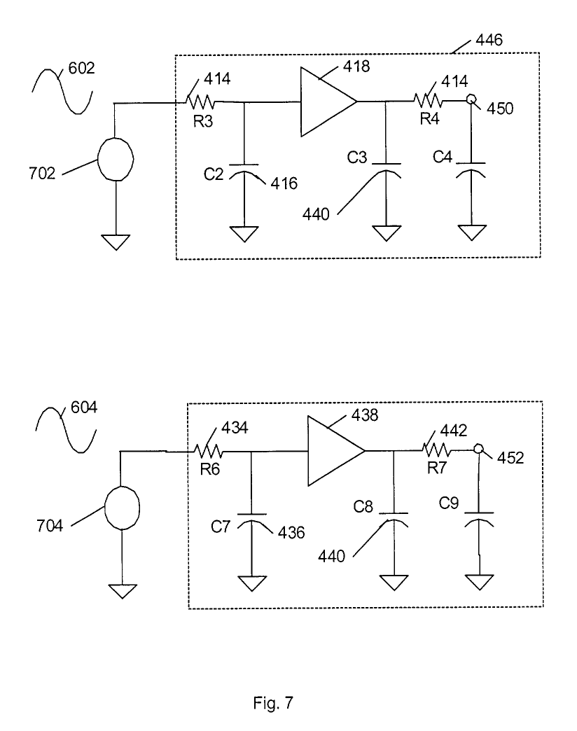

FIG. 7 illustrates the simulation of a circuit using the driving point waveform computed in FIG. 6, according to the present invention. A voltage source 702 is coupled to hierarchical block 446. Voltage source 702 provides driving point waveform 602 measured in FIG. 6. Similarly, voltage source 704 is coupled to hierarchical block 448 and provides driving point waveform 604. The desired simulations and/or timing verifications are then performed. For example, measurements, such as signal slew rate for example, are taken at measurement nodes 450 and 452 respectively. At least one advantage of the present invention is the use of the signal waveform properties produced from modified circuit 600 to simulate and/or verify each hierarchical block 446 and 448 separately and accurately. To perform the measurement on circuit 400 would be more time consuming. Additionally, embodiments of the present invention provide a method to improve the overall efficiency and complexity of performing circuit simulation and and/or verification of complex circuits.

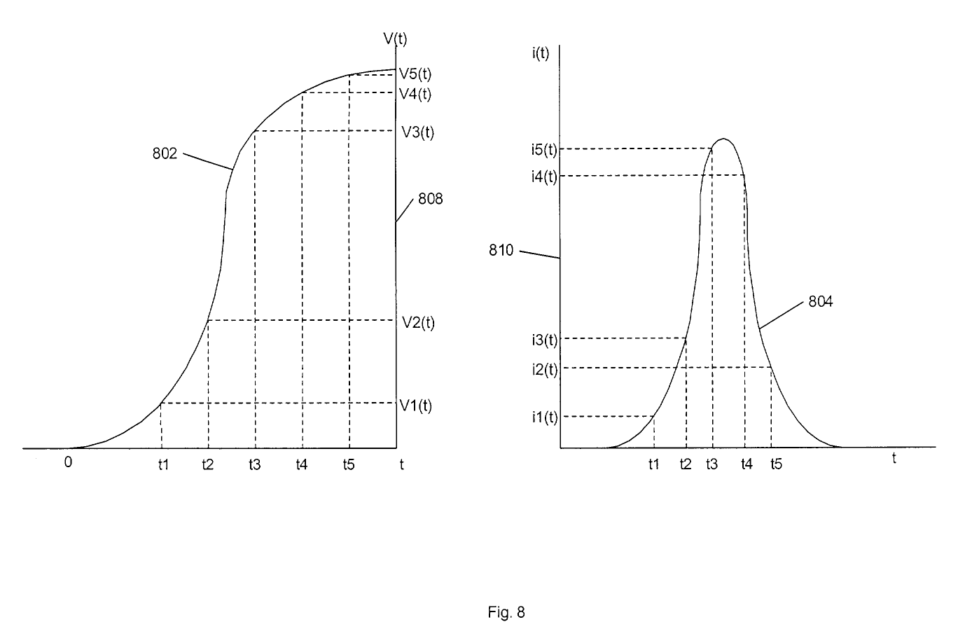

FIG. 8 is a block diagram illustrating exemplary driving point waveforms for use in computing realizable reduced order model circuits according to the present invention. FIG. 8 includes driving point voltage waveform 802 and driving point current waveform 804. A horizontal-axis 806 of driving point waveforms 802 and 804 represent time, while a vertical-axis 808 of driving point waveform 802 represents voltage and a vertical-axis 810 of driving point waveform 804 represents current.

Values from driving point waveforms 802 and 804 are preferably used to calculate values of components in a realizable reduced order model, according to an embodiment of the present invention. For example, solving for R and C in Equation 1 above produces:

$$\begin{matrix}C = \frac{{i}_{lk} \cdot {V}_{jk} - {i}_{jk} \cdot {V}_{kl}}{{\hat{i}}_{jk} \cdot {i}_{kl} - {i}_{jk} \cdot {\hat{i}}_{kl}} ; and \\ R = \frac{{V}_{kl} - {\hat{i}}_{kl} \cdot \frac{1}{C}}{{i}_{kl}}\end{matrix}$$

Voltage values from driving point waveform 802, such as V₁(t), V₂(t), V₃(t), V₄(t), and V₅(t) along with current values from driving point waveform 804, such as i₁(t), i₂(t), i₃(t), i₄(t), and i₅(t), and the integrals and derivatives of driving point current waveform 804, are preferably used to calculate the component values of R and C to provide a realizable reduced order model according to one embodiment of the present invention (for example, as described in the exemplary pseudo code provided above with reference to FIG. 2).

FIG. 9 depicts a block diagram of a computer system 910 suitable for implementing the present invention. Computer system 910 includes a bus 912 which interconnects major subsystems of computer system 910 such as a central processor 914, a system memory 916 (typically RAM, but which may also include ROM, flash RAM, or the like), an input/output controller 918, an external audio device such as a speaker system 920 via an audio output interface 922, an external device such as a display screen 924 via display adapter 926, serial ports 928 and 930, a keyboard 932 (interfaced with a keyboard controller 933), a storage interface 934, a floppy disk drive 936 operative to receive a floppy disk 938, and a CD-ROM drive 940 operative to receive a computer readable media 942 (e.g., a CD-ROM). Also included are a mouse 946 (or other point-and-click device, coupled to bus 912 via serial port 928), a modem 947 (coupled to bus 912 via serial port 930) and a network interface 948 (coupled directly to bus 912).

Bus 912 allows data communication between central processor 914 and system memory 916, which may include both read only memory (ROM) or flash memory (neither shown), and random access memory (RAM) (not shown), as previously noted. The RAM is generally the main memory into which the operating system and application programs are loaded and typically affords at least 66 megabytes of memory space. The ROM or flash memory may contain, among other code, the Basic Input-Output system (BIOS) which controls basic hardware operation such as the interaction with peripheral components. Applications resident with computer system 910 are generally stored on and accessed via a computer readable medium, such as a hard disk drive (e.g., fixed disk 944), an optical drive (e.g., CD-ROM drive 940), floppy disk unit 936 or other storage medium. Additionally, applications may be in the form of electronic signals modulated in accordance with the application and data communication technology when accessed via network modem 947 or interface 948.

Storage interface 934, as with the other storage interfaces of computer system 910, may connect to a standard computer readable medium for storage and/or retrieval of information, such as a fixed disk drive 944. Fixed disk drive 944 may be a part of computer system 910 or may be separate and accessed through other interface systems. Many other devices can be connected such as a mouse 946 connected to bus 912 via serial port 928, a modem 947 connected to bus 912 via serial port 930 and a network interface 948 connected directly to bus 912. Modem 947 may provide a direct connection to a remote server via a telephone link or to the Internet via an internet service provider (ISP). Network interface 948 may provide a direct connection to a remote server via a direct network link to the Internet via a POP (point of presence). Network interface 948 may provide such connection using wireless techniques, including digital cellular telephone connection, Cellular Digital Packet Data (CDPD) connection, digital satellite data connection or the like.

Many other devices or subsystems (not shown) may be connected in a similar manner (e.g., bar code readers, document scanners, digital cameras and so on). Conversely, it is not necessary for all of the devices shown in FIG. 9 to be present to practice the present invention. The devices and subsystems may be interconnected in different ways from that shown in FIG. 9. The operation of a computer system such as that shown in FIG. 9 is readily known in the art and is not discussed in detail in this application. Code to implement the present invention may be stored in computer-readable storage media such as one or more of system memory 916, fixed disk 944, CD-ROM 942, or floppy disk 938. Additionally, computer system 910 may be any kind of computing device, and so includes personal data assistants (PDAs), network appliance, X-window terminal or other such computing device. The operating system provided on computer system 910 may be MS-DOS®, MS-WINDOWS®, OS/2®, UNIX®, Linux® or other known operating system. Computer system 910 also supports a number of Internet access tools, including, for example, an HTTP-compliant web browser having a JavaScript interpreter, such as Netscape Navigator®, Microsoft Explorer® and the like.

Moreover, regarding the signals described herein, those skilled in the art will recognize that a signal may be directly transmitted from a first block to a second block, or a signal may be modified (e.g., amplified, attenuated, delayed, latched, buffered, inverted, filtered or otherwise modified) between the blocks. Although the signals of the above described embodiment are characterized as transmitted from one block to the next, other embodiments of the present invention may include modified signals in place of such directly transmitted signals as long as the informational and/or functional aspect of the signal is transmitted between blocks. To some extent, a signal input at a second block may be conceptualized as a second signal derived from a first signal output from a first block due to physical limitations of the circuitry involved (e.g., there will inevitably be some attenuation and delay). Therefore, as used herein, a second signal derived from a first signal includes the first signal or any modifications to the first signal, whether due to circuit limitations or due to passage through other circuit elements which do not change the informational and/or final functional aspect of the first signal.

The foregoing described embodiment wherein the different components are contained within different other components (e.g., the various elements shown as components of computer system 910). It is to be understood that such depicted architectures are merely examples, and that in fact many other architectures can be implemented which achieve the same functionality. In an abstract, but still definite sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediate components. Likewise, any two components so associated can also be viewed as being “operably connected”, or “operably coupled”, to each other to achieve the desired functionality.

What is claimed is:

1. A method comprising:
computing a realizable reduced-order model for a circuit, wherein said computing comprises:
calculating a value of each component of said realizable reduced-order model, said calculating based upon properties of a signal provided to said circuit and a voltage range associated with said circuit, and
if at least one of said values is not positive, modifying said voltage range and repeating said calculating until each of said values is positive.

2. The method of claim 1, wherein modifying said voltage range comprises:
incrementally decreasing said voltage range.

3. The method of claim 1, wherein said properties of said signal comprises:
a plurality of data points taken from an input waveform, a derivative of said input waveform, and an integral of said input waveform.

4. The method of claim 3 further comprising:
defining said input waveform;
computing said derivative and said integral of said input waveform; and
initializing said voltage range to Vss to Vdd.

5. The method of claim 3, wherein the reduced-order model is a reduced-order driving point admittance model.

6. The method of claim 5, wherein said calculating comprises:
calculating a value for a resistor and a value for a capacitor value for a L-type first order circuit model by utilizing said data points to solve a system of equations derived from said L-type first order circuit.

7. The method of claim 5, wherein said calculating comprises:
calculating a value for a resistor, a value for an inductor and a value for a capacitor for a L-type second order circuit model by utilizing said data points to solve a system of equations derived from said L-type second order circuit.

8. The method of claim 5, wherein said calculating comprises calculating a value for a resistor, a value for a first capacitor and a value for a second capacitor for a Pi-type second order circuit model by utilizing said data points to solve a system of equations derived from said Pi-type second order circuit.

9. The method of claim 1, wherein said circuit is a non-linear circuit.

10. The method of claim 1, wherein said input waveform is non-monotonic waveform.

11. The method of claim 1, further comprising:
dividing said circuit into a plurality of hierarchical blocks;
computing a realizable reduced-order model for each hierarchical block; and
replacing each hierarchical block with a corresponding computed realizable reduced-order model to provide a modified circuit.

12. The method of claim 11, further comprising:
generating a driving point waveform from said modified circuit; and
simulating said circuit by applying said driving point waveform to a hierarchical block.

13. The method of claim 1, wherein said calculating comprises:
solving a set of linear equations associated with realizable reduced-order model to determine said value for each component of said realizable reduced-order model.

14. The method of claim 13, wherein said calculating further comprises:
selecting a plurality of voltage points within said voltage range, said plurality of voltage points used to solve said set of linear equations, and said plurality at least one greater than the number of variable associated with said set of linear equations.

15. A computer program product encoded in computer readable media, said computer program product comprising:
a first set of instructions, executable on a computer system, configured to compute a realizable reduced-order model for a circuit, wherein said first set of instructions further comprises:
a first sub-set of instructions, executable on said computer system, configured to calculate a value of each component of said realizable reduced-order model, said first sub-set of instructions receiving as input properties of a signal provided to said circuit and a voltage range associated with said circuit, and
a second sub-set of instructions, executable on said computer system, configured to modify said voltage range and repeat said calculating until each of said values is positive, if at least one of said values is not positive.

16. The computer program product of claim 15, said first set of instructions further comprising:
a third sub-set of instructions, executable on a computer system, configured to incrementally decrease said voltage range.

17. The computer program product of claim 15, wherein said properties of said signal comprises:
a plurality of data points taken from an input waveform, a derivative of said input waveform, and an integral of said input waveform.

18. The computer program product of claim 17, said first set of instructions further comprising:
a fourth sub-set of instructions, executable on a computer system, configured to define said input waveform;
a fifth sub-set of instructions, executable on a computer system, configured to compute said derivative and said integral of said input waveform; and
a sixth sub-set of instructions, executable on a computer system, configured to initialize said voltage range to Vss to Vdd.

19. The computer program product of claim 15, further comprising:
a second set of instructions, executable on a computer system, configured to divide said circuit into a plurality of hierarchical blocks;
a third set of instructions, executable on a computer system, configured to compute a realizable reduced-order model for each hierarchical block; and
a fourth set of instructions, executable on a computer system, configured to replace each hierarchical block with a corresponding computed realizable reduced-order model to provide a modified circuit.

20. The computer program product of claim 15, further comprising:
a fifth set of instructions, executable on a computer system, configured to generate a driving point waveform from said modified circuit; and
a sixth set of instructions, executable on a computer system, configured to simulate said circuit by applying said driving point waveform to a hierarchical block.

21. The computer program product of claim 15, wherein said first sub-set of instructions are further configured to solve a set of linear equations associated with realizable reduced-order model to determine said value for each component of said realizable reduced-order model.

22. The computer program product of claim 21, wherein said first sub-set of instructions are further configured to select a plurality of voltage points within said voltage range, said plurality of voltage points used to solve said set of linear equations, and said plurality at least one greater than the number of variable associated with said set of linear equations.

23. A computer system, comprising:
means for computing a realizable reduced-order model for a circuit, wherein said means for computing comprises:
means for calculating a value of each component of said realizable reduced-order model, said calculating based upon properties of a signal provided to said circuit and a voltage range associated with said circuit, and
if at least one of said values is not positive, means for modifying said voltage range and repeating said calculating until each of said values is positive.

24. The computer system of claim 23, further comprising:
means for incrementally decreasing said voltage range.

25. The computer system of claim 23, further comprising:
means for computing a derivative and an integral of said signal; and
means for initializing said voltage range to Vss to Vdd.

26. The computer system of claim 23, further comprising:
means for dividing said circuit into a plurality of hierarchical blocks;
means for computing a realizable reduced-order model for each hierarchical block; and
means for replacing each hierarchical block with a corresponding computed realizable reduced-order model to provide a modified circuit.

27. The computer system of claim 23, further comprising:
means for generating a driving point waveform from said modified circuit; and
means for simulating said circuit by applying said driving point waveform to a hierarchical block.

28. A computer system comprising:
a processor;
computer readable medium coupled to said processor; and
computer code, encoded in said computer readable medium, configured to cause said processor to:
compute a realizable reduced-order model for a circuit, wherein said computer code configured to cause said processor to compute is further configured to configured to cause said processor to:
calculate a value of each component of said realizable reduced-order model, said calculating based upon properties of a signal provided to said circuit and a voltage range associated with said circuit, and
if at least one of said values is not positive, means for modify said voltage range and repeat said calculating until each of said values is positive.

29. The computer system of claim 28, wherein said computer code is further configured to cause said processor to incrementally decrease said voltage range.

30. The computer system of claim 28, wherein said computer code is further configured to:
compute a derivative and an integral of said signal; and
initialize said voltage range to Vss to Vdd.

31. The computer system of claim 28, wherein said computer code is further configured to:
divide said circuit into a plurality of hierarchical blocks;
compute a realizable reduced-order model for each hierarchical block; and
replace each hierarchical block with a corresponding computed realizable reduced-order model to provide a modified circuit.

32. The computer system of claim 28, wherein said computer code is further configured to:
generate a driving point waveform from said modified circuit; and
simulate said circuit by applying said driving point waveform to a hierarchical block.
